(19) United States
(12) Patent Application Publication
(10) Pub. No.: US 2007/0005669 A1
(43) Pub. Date: Jan. 4, 2007

(54) METHOD AND SYSTEM FOR AUTOMATED DISK I/O OPTIMIZATION OF RESTORED DATABASES

(76) Inventors: CHRISTOPH KARL MUELLER, Esslingen A. N. (DE); THOMAS RITTER, Herrenberg (DE)

Correspondence Address: IBM CORPORATION;INTELLECTUAL PROPERTY LAW, 11400 BURNET ROAD, AUSTIN, TX, 78758, US

(21) Appl. No.: 11/423,332

(22) Filed: Jun. 9, 2006

(30) Foreign Application Priority Data
Jun. 9, 2005 (EP) 05105034.2

(51) Int. Cl. G06F 17/30

(52) U.S. Cl. 707/204

(57) ABSTRACT

The present invention provides a new method and system for automated I/O optimization of restored databases. At the time a backup image of the database is created metadata of the database are automatically generated. The metadata includes information about the physical database layout and disk I/O performance on a source system. Metadata and backup image of the database are then backed up on an external storage device together resulting in a new, extended backup image. In a preferred embodiment the backup image of the database includes the metadata. At the time a restore of the backup image on a target system is made the metadata and information about number and sizes of the disks on said target system are retrieved. Based on that information an optimized physical database layout for the database on the target system with respect to an optimized I/O performance is calculated. Finally, the backup image is restored on the target system according to the optimized physical database layout.

### FIELD OF THE PRESENT INVENTION

The present invention relates in general to restore of databases, and in particular to a method and system for automated disk I/O optimization of restored databases.

### BACKGROUND OF THE INVENTION

Any relational database management system (subsequently called RDBMS), presented by a collection of tables, is organized into multiple parts called “tablespaces”.

First of all, a tablespace is a logical storage structure to which database objects like tables, indices and large objects will be assigned to. To store the database objects physically, each tablespace consists of at least one so called “tablespace file” (subsequently TF), which is an allocation of physical storage, such as a file or a device. A single tablespace can also be spread over one or more tablespace files, whereas each tablespace file can be of different sizes. Further, it is possible for multiple tablespace files to be created either on the same physical disk or on multiple physical disks. FIG. 1A illustrates the relationship between tables and tablespaces within a database, and the tablespace files associated with that database.

The tables T1 and T2 are in tablespace A, which spans tablespace files 0, 1, 2, 3 and 4. The table T3 is in tablespace B in tablespace file 5. This example shows additionally the physical database layout. The physical database layout reflects the number, size, grouping and distribution (location) of the tablespace files. The tablespace files 0 and 1 are on the same physical disk, whereas all others are on separate physical disks, and the tablespace files are of different sizes. Additionally, the different representation of the tablespace files (striated vs. solid fill colour) indicates their different disk I/O rates. Disk I/O is denoted by the number of I/O operations (read and write) on files at a disk. A high disk I/O rate denoted by frequent and continuous file accesses can slow down or block the data transfer from concurrent processes accessing the same disk.

One can say, if disk I/O performance becomes bad it results in overall longer response times.

In the example above, tablespace files of tablespace A are solid filled which means these files (the tablespace) are read or write very frequently by processes performing intensive sequential I/O and random I/O, whereas the tablespace file of tablespace B is striated filled which means the file is read or write very lightly by a process performing random I/O.

Typically, operational databases are characterised by significant amount of changes every day. These changes can be grouped into structural changes (adding, deleting or updating of tablespaces), and data changes (adding, deleting or updating of table data).

Hence, to guarantee the existence of the data of the database and to be able to restore it RDBMSs provide appropriate backup mechanisms to protect the data against unexpected logical and physical errors.

The concept of a database backup is nearly the same as any other data backup: taking a copy (backup image) of the database data and storing it on a different medium (e. g. tape drive) to be prepared to restore the database in case of failure or damage to the original.

Sensitive databases are typically backed up at a daily basis as part of a disaster recovery plan to be protected in case of failures. Vital backup images are necessary to shorten productive downtimes if the original database is damaged. FIG. 1B shows a backup process where all tablespaces of the database are backed up (also called full or complete database backup).

The backup image created by the database backup process consists of all tablespace files of all tablespaces associated with the database. Backup images are typically stored on external storage devices/systems.

During the lifecycle of a database there might be different scenarios, where it is necessary to recreate that database. Hence, RDBMSs provide a restore mechanism to support the recreation of a database to a defined point in time. Two different kinds of database restore scenarios are imaginable namely restore after logical or physical errors to the database structure by using “standard restore” techniques of RDBMSs—the restored physical database structure is identical to the original, and restore by using the so called “redirected restore” technique.

Here, simultaneously with the restore of the actual database data their physical structure can be adapted additionally. This is useful for example for creating a duplicate (clone) of the original database typically on another machine, which can have different hardware characteristics in view of the original machine, for example the available storage hardware (disks). FIG. 1C shows a standard restore process where all tablespaces of the database are restored (also called full or complete database restore).

The backup image created from the backup process previously is read by the restore process from external storage. It consists of all tablespace files of all tablespaces associated with the database. Thereby, the physical database layout of the restored database is not changed during the restore process. If one see the sample database above, their physical layout is not optimal in view of the disk I/O performance. It has different tablespace file sizes within a tablespace. That results in an unequal distribution of the table data within the tablespace files. In case of parallel table scans (each tablespace file is accessed by a separate process) that would decrement the degree of parallelization, because of the processes deal with different sets of data. Furthermore, it has tablespace files with high disk I/O load on the same physical disk. That results in an unbalanced I/O load of the system, whereby concurrent processes, each accessing a different tablespace file on that disk, will be blocked.

That is an important issue because database disk I/O amounts to the overall database performance about a third. I/O intensive database actions are for example sorting SQL statements. They issue implicit table scans, which generate high disk I/O load.

### PRIOR ART

Because of today, RDBMS restore processes (standard restore as well as redirected restore) do not take care about the disk I/O performance of restored databases. Databases are restored using the identical physical layout as reflected in the backup image. With current techniques, a restored database with a physical layout which is optimal in view of disk I/O performance could be realized manually, too. For it, following steps would be necessary namely analyse the physical layout of the source database, restore the database with its original physical layout, and adapt the physical database layout of the source database in view of disk I/O performance with appropriate RDBMS or operating system commands.

The disadvantages for the manual procedure above comprise three categories namely administrative overhead, physical rearrangement of tablespace files, and no reproducible workflow. The following formula gives a more abstract view of the method above:

$$\begin{matrix}Overall time = ( Time for administrative overhead ) \\ ( Time for database restore ) \\ ( Time for physical rearrangement of tablespace files )\end{matrix}$$

Obviously, the goal should be providing a database restore technique with included disk I/O optimization. That would lead to the formula:

$$Overall time = Time for database restore$$

Back to the sample database above, an adapted physical layout after a database restore is given in FIG. 1D. Here, all tablespace files of a tablespace are of equal sizes (called normalized). The other difference in the layout is that the tablespace files 1 and 5 are exchanged in their physical location. Now, the less I/O critical tablespace file 5 is on the first disk together with the I/O intensive file 0. For that set of physical resources the new physical layout is good for disk I/O performance.

If additional physical disks are attached to the machine, the physical layout should be adapted by the RDBMS restore process as to be seen in FIG. 1E.

The additional disk makes it possible to spread the I/O load as evenly as possible across all the available physical disks. Now, one can say the physical database layout of the target database is optimal in view of disk I/O performance.

### OBJECT OF THE INVENTION

Starting from this, the object of the present invention is to provide a method and system for automated disk I/O optimization of restored databases by avoiding the disadvantages of the above-mentioned prior art.

### SUMMARY OF THE INVENTION

The present invention provides a new method and system for automated I/O optimization of restored databases. At the time a backup image of the database is created metadata of the database are automatically generated. The metadata includes information about the physical database layout and disk I/O performance in a source system. Metadata and backup image of the database are then backed up on an external storage device together resulting in a new, extended backup image format. In a preferred embodiment the backup image of the database includes the metadata. At the time a restore of the backup image on a target system is made the metadata and information about number and sizes of the disks on said target system are retrieved. Based on that information an optimized physical database layout for the database on the target system with respect to an optimized I/O performance is calculated. Finally, the backup image is restored on the target system according to the optimized physical database layout.

### BRIEF DESCRIPTION OF THE DRAWINGS

In the following, preferred embodiments of the present invention will be described in greater detail by making reference to the drawings in which:

FIG. 1A shows tablespaces and tables within a database,

FIG. 1B shows a backup process without the present invention,

FIG. 1C shows a restore process without the present invention,

FIG. 1D/E show an adapted physical database layout,

FIG. 2A shows the differences between the prior art backup process and the inventive backup process,

FIG. 2B shows a flow diagram of the database and metadata backup according to the present invention,

FIG. 2C shows the inventive database restore process according to the present invention, and

FIG. 2D shows a flow diagram of the inventive database restore process according to the present invention.

Imaginable are two solutions for achieving the fully automatic disk I/O optimization of restored databases. The first is to integrate the new mechanism representing the invention into the existing RDBMS backup and restore functions. This solution provides the best performance, flexibility and reliability. A second solution is based on external applications which invoke RDBMS backup or restore functions via so called application programming interfaces (API) provided by the database system. Here, the current RDBMS backup and restore implementations have not to be changed, because of the new method is embedded in the application itself.

The solutions above share one common property, the algorithm or the procedure behind, which makes it possible to guarantee an optimized physical layout in view of disk I/O performance of restored databases. The only difference is the integration point, either in the RDBMS itself or as part of external applications. Thus, only the optimization procedure itself will be described in more detail.

To perform an I/O based optimization in combination with a database restore, additional information is needed about the physical layout of the original database and its I/O performance (subsequently “metadata”), whereby different metadata are required for various kinds of I/O optimization steps:

Normalization of Tablespace Files

Data that are needed to make all tablespace files of a tablespace the same size (normalize) in the restored database are the combined size of all tablespace files of each tablespace, the number of tablespace files of each tablespace. Using these information, the average size of a tablespace file can be calculated on a per tablespace base and can be used to make all tablespace files of a single tablespace having the same size.

Disk I/O Balancing by Means of Read/Write Statistics

The usage statistics per tablespace in an operative database will be gathered continually by most of the presently available RDBMSs itself, e.g. how often the RDBMS accessed each tablespace file or tablespace for reading and writing data. They are stored in so-called system tables which can be queried by SQL-statements manually or by an application using either SQL-statements or appropriate API-calls. The tablespace file usage statistics are included into the metadata to have it available during database restore. The read and write numbers of a tablespace file represents the I/O load of this file and further it influences the I/O load of the associated disk. If more than one physical disk is available for restoring the database to, the tablespace files can be arranged by use of the information from the metadata in such a way that frequently accessed tablespace files are distributed on separate physical disks.

Separation of Table Data and Their Indices

Typically, table data and index data are stored separately in different tablespace files. As table data and the indices of these tables might be accessed frequently within a transaction, the I/O performance can be additionally improved by avoiding that a table and its indices reside on the same physical disk. The information where the index data and table data are stored can be queried by SQL-statements from the RDBMS system tables either manually or by an application. Thus, information concerning tablespace files containing table data and index data is included into the metadata. If more than one physical disk is available for restoring the database to, the tablespace files can be arranged by use of the information from the metadata in such a way that table data and its indices are spread on separate physical disks.

The internal representation of metadata is reflected as a tree structure of depth two, whereby the root node of the tree contains information about the database (database name, number of tablespaces, creation time of backup), the internal tree nodes contain information concerning the tablespaces of the database (tablespace name, number of tablespace files, overall tablespace size) and the leaf nodes represents information about the tablespace files (tablespace file name, tablespace file size, original location, fill ratio, usage statistics, data or indices). That tree structure is built and hold in the machines main memory as long as it is written to external storage as part of the extended backup image.

All metadata described above must be collected at the time the backup image is created, because of with these and information based on the storage environment of the target machine (e.g. number of physical disks), the restore process feeds the new optimization algorithm to calculate an optimal physical database layout used by the restore process for restoring the real database data into it.

It might be problematical to collect the metadata, if the original database is not available (in case of a disaster) or if the database is to be restored on a different location, for example if it has to be copied (cloned). To guarantee always having the metadata available to build a disk I/O optimized database in combination with a restore, the metadata have to be included into the backup image. That result in a new, extend backup image format, consisting of one or more metadata blocks at the beginning of the image representing physical and statistical information of the database followed by the real database data.

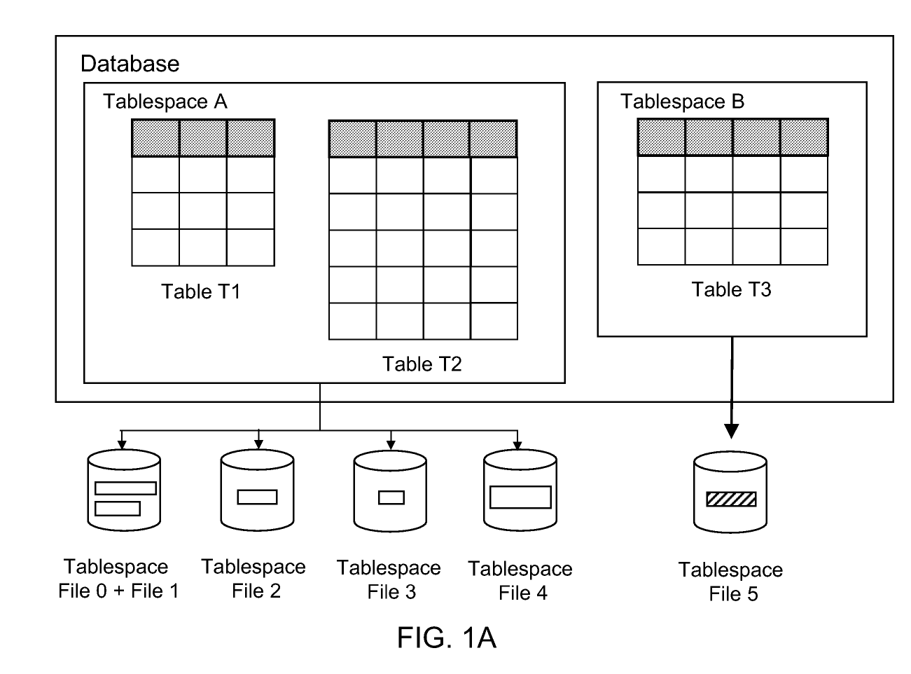

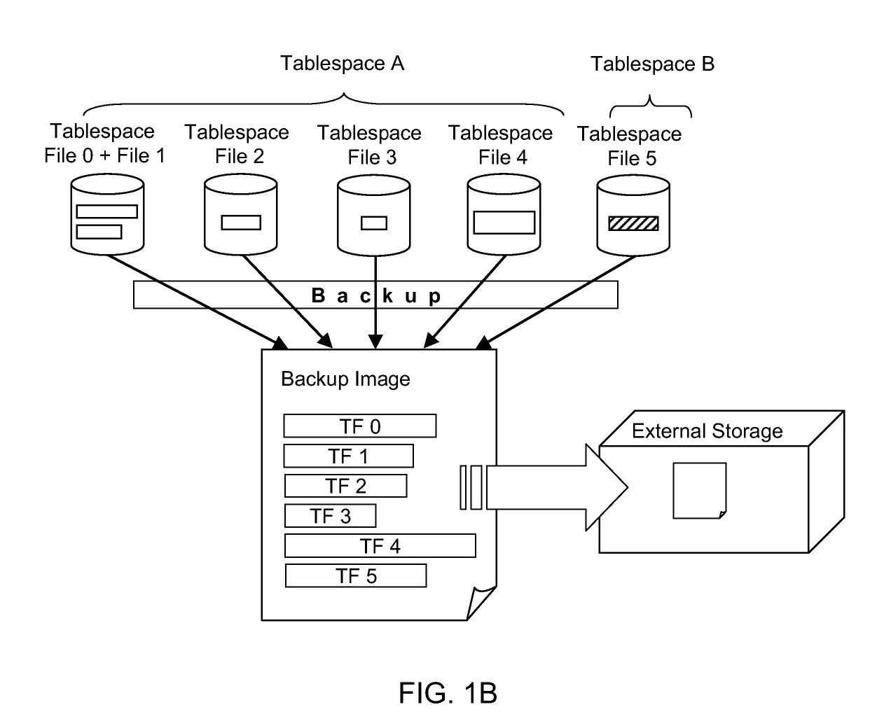

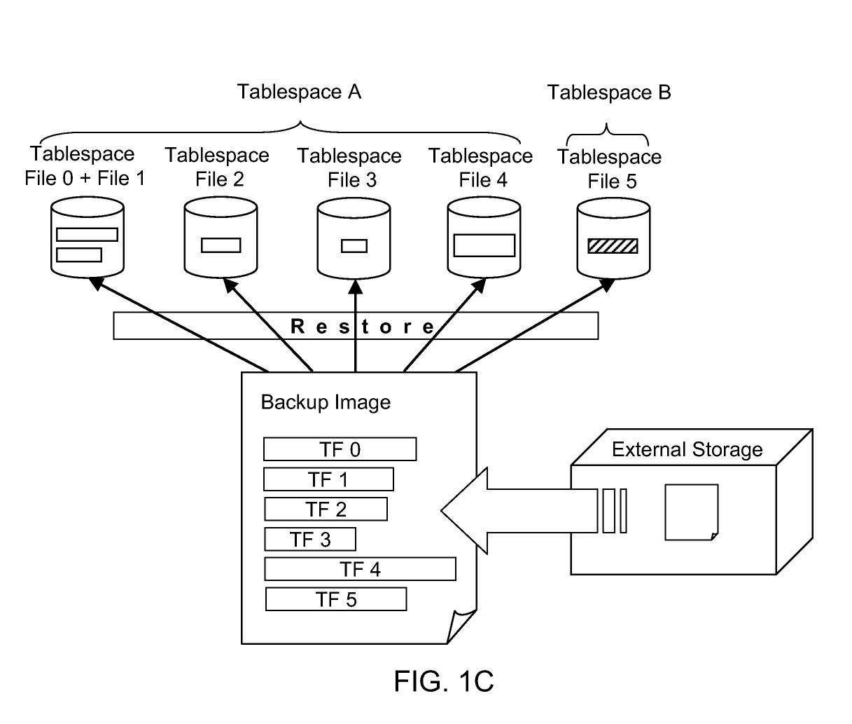

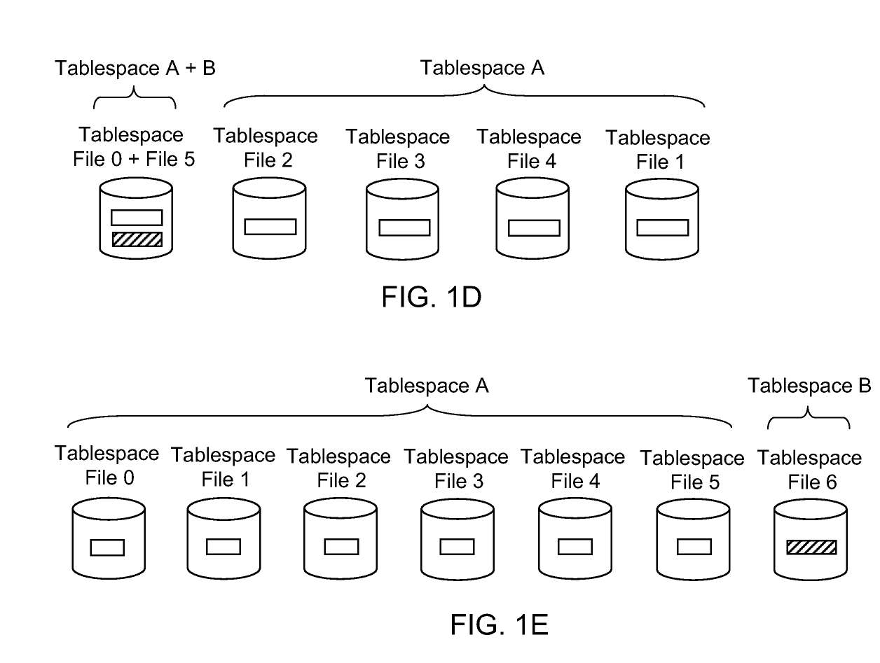

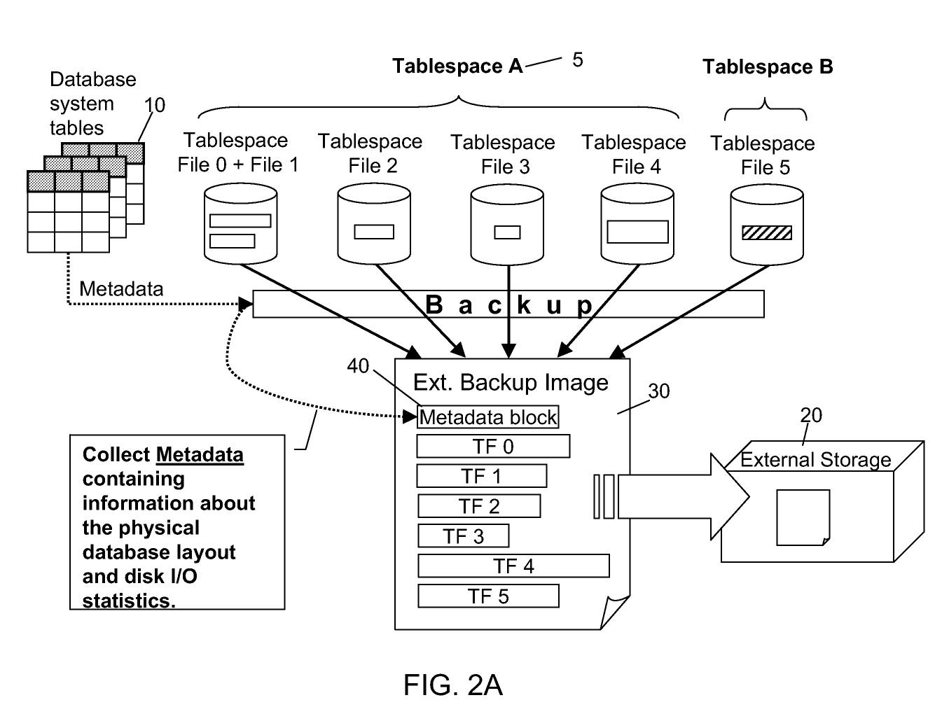

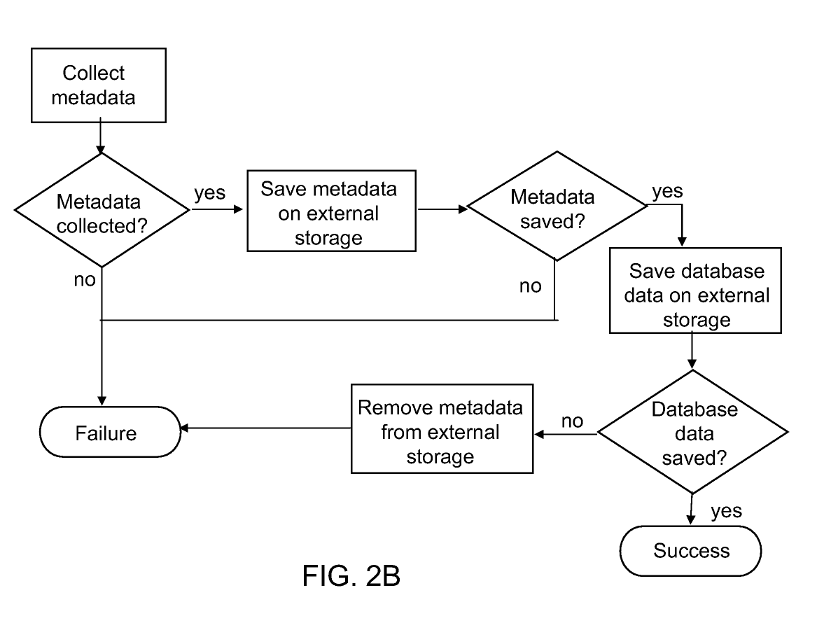

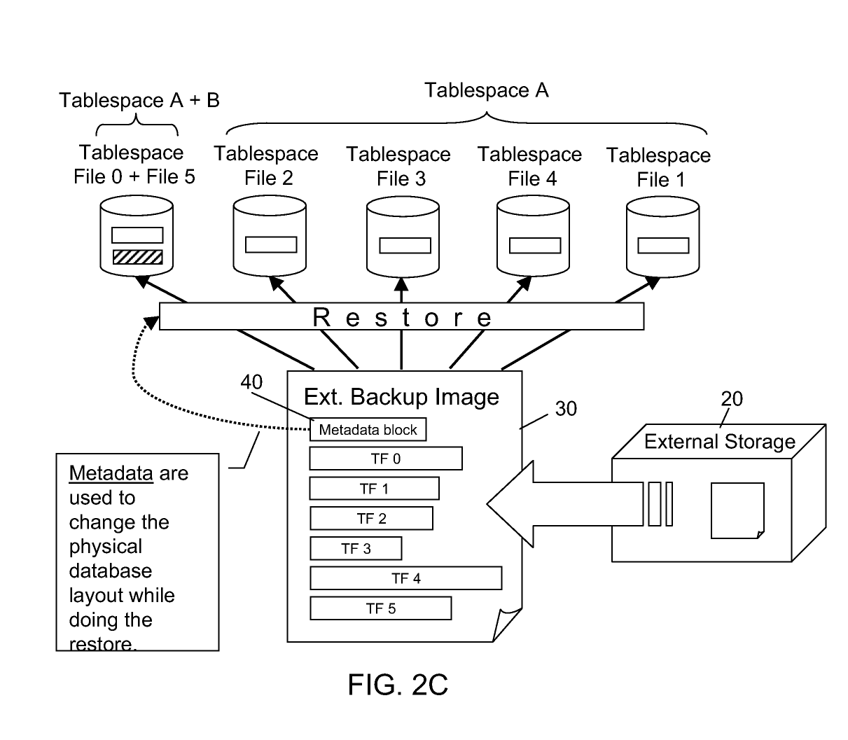

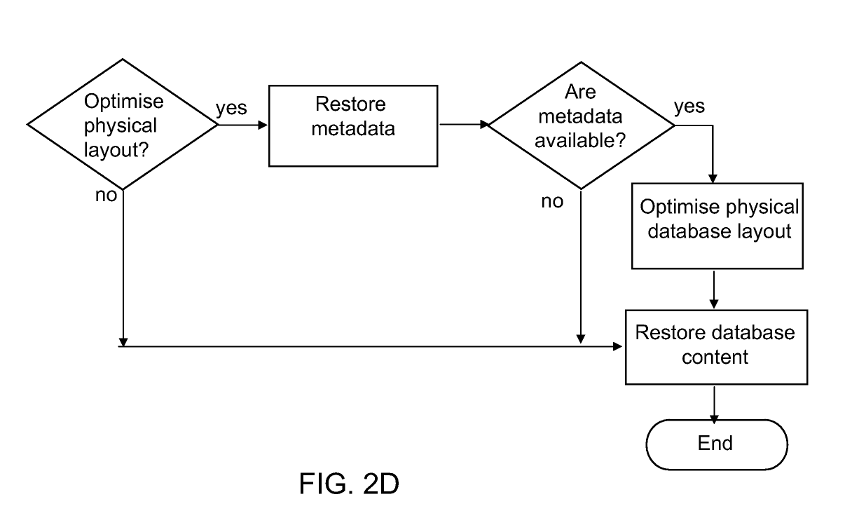

FIG. 2A highlights the differences between the current database backup as shown in FIG. 1A and a backup process according to the present invention.

The metadata 40 required for the optimization process are stored among others in system tables 10 most RDBMS uses for internal processing. Thus, the I/O performance relevant information can easily be gathered by appropriate SQL-statements and placed into the backup image exclusively.

As stated before, the metadata 40 are placed at the first position (block) of the extended backup image 30 by the backup process which sends the metadata 40 as a part of the extended backup image 30 from the machines main memory to external storage 20. It guarantees that they can easily be restored first. This is a requirement to be able to build a new and optimized physical database layout prior restoring the real database data. If the metadata 40 are stored, the database data will be concatenated directly behind the last metadata block.

All metadata 40 described above must be gathered for each database backup that is to be used for creating an optimized physical database layout during subsequent database restores. Thus, the integration of the metadata 40 into the extended backup image 30 makes one independent from the availability of the original database, where the backup was taken.

Another embodiment of the present invention might be that the backup image and metadata 40 are separately sent to the external storage device (backup system; 20). In such a case it must be ensured that metadata 20 and backup image form an extended backup image 30 at the external storage device side 20.

FIG. 2B illustrates the actions that have to be taken to create a database backup combined with a metadata backup. In first step metadata are collected from the system tables. If no metadata are collectable then a backup of the backup image of the database is made without I/O optimization. If metadata are available then they are backed up as a part of the backup image (extended backup image) on an external storage device followed by real database data. In the case of failure the already stored metadata are removed from the external storage device.

During the restore of the database backup image, the physical layout of the target database is optimized in regard to the disk I/O performance of the database by using the metadata stored in the backup image.

As stated earlier, a redirected restore must be performed to do this, as a standard restore does not allow changing the physical database layout. As illustrated in FIG. 2C metadata are used to change the physical layout of the database during the restore. The new, optimizing restore process includes the following steps as shown in FIG. 2D:

First of all, the end user initiating the restore must decide whether an optimization of the physical layout should be done or not.

If no metadata are included in the backup image, a standard restore without optimization can be done in order to ensure backward compatibility with older backup images.

If the optimization should be done, the metadata must be retrieved from the extended backup image into the machine main memory, where the internal tree structure as described earlier is rebuilt according to the original physical database layout. Changes to internal representation of the metadata, which corresponds to an update of the physical database layout, have to be done in the next step.

Once the metadata are available in memory, the restore including the adjustment of the physical database layout can be started. Thereby, the first step the restore process has to be done is to process/reorganize the metadata tree structure depending on the optimization deep specified, which can cover only single optimization characteristics as well as a combination of them listed below:

Make Tablespace Files of Tablespaces Equal Sized (Normalization)

Using the total size of the tablespace and the number of files, which are included in the metadata, the average size of a tablespace file can be calculated and assigned to each tablespace file. The following formula calculates the new normalization layout of tablespace files:

$$New TS file size = ( Sum of TS file sizes ) / ( Number of TS files )$$

Obviously, using that formula to build the physical database layout, the tablespace files of a tablespace are all of the same size (normalized).

Use Optimal Disk Utilization

The number and size of physical disks on the target system can be acquired via operating system or API calls. The distribution of the tablespace files on the physical disks is done by placing the files of each tablespace round robin on the available physical disks.

The number of tablespace files of a tablespace can be adjusted in such a way that it has at most one tablespace file on one physical disk of the target system. To achieve this, from each tablespace that has more tablespace files than physical disks available on the target system, tablespace files are removed and the storage space allocated in them is distributed on the remaining ones.

Equivalently, tablespaces that have less tablespace files than available physical disks can get more tablespace files by shrinking the allocated space of the existing files and creating new ones. This maximises the I/O performance of the database by leaving no physical disk unused. The following formula calculates the new tablespace file layout depending on the physical disks available on the target system:

$$New TS file size = ( Sum of TS file sizes ) / ( Number of disks )$$

Obviously, using that formula to build the physical database layout, the tablespace files of a tablespace are normalized and equally distributed over the available physical disks of the system using the round robin technique.

Use Statistics to Balance I/O Load

Using the tablespace statistics, the tablespace files of a tablespace can be arranged on the physical disks in such a way, that the average I/O load per disk is approximately equal. The most frequently used tablespace files of a tablespace are on different physical disks under notice of predefined thresholds, tablespace files of a tablespace containing table data and index data are on different physical disks.

If the reorganization of the internal metadata tree structure is finished, the restore process uses this new metadata structure to create the tablespace files accordingly in the target machines file system. Then, as the last step of the restore process, the real database data is restored from the extended backup image into the newly created tablespace files of the target database.

The method for calculating the new layout for the restored data is briefly summarized as follows:

Starting with the normalization step by calculating the equal size of tablespace files per table space,

Continuing with distribution of the normalized tablespace files over the available number of disks resulting in balanced distribution of the devices, and

With statistical processing by using a defined threshold for average read/write accesses per physical device, which should not be exceeded, if more than one tablespace file is placed on that device and distributing tablespace files exceeding that threshold over the available disks not exceeding the defined threshold.

As the last step of the restore process, the database content is restored from the extended backup image into the newly created tablespace files of the target database.

After the database restore is finished, the physical layout of the restored database in view of disk I/O performance is optimal dependent on the physical resources of the target machine. No further administrative steps are to be done. The database can be used immediately.

1. A method for automated disk I/O optimization of restored databases comprising:
automatically generating metadata related to a said database, wherein said metadata specifies a physical layout and disk I/O performance of said database on a source system,
generating a backup image of database data of said database, backing up said metadata and said backup image on a storage device,
retrieving said metadata from said storage device,
accessing storage disk information indicating a number and size of each storage disk on a target system,
determining an optimized physical database layout of said backup image on said target system with respect to I/O performance based on said metadata and said storage disk information, and
restoring said backup image on said target system utilizing said optimized physical database layout.

2. The method according to claim 1, wherein said determining comprises:
calculating a tablespace file size resulting in tablespace files of equal size per table space,
distributing said tablespace files over an available number of storage disks of said target system resulting in a balanced distribution of tablespace files,
rearranging said tablespace files of said balanced distribution utilizing a defined threshold of maximal read/write access,
identifying tablespace files exceeding said defined threshold, and automatically rearranging said tablespace files exceeding said defined threshold to disks of said storage disks not exceeding said defined threshold.

3. The method according to claim 1, wherein said metadata are added to said backup image to generate an extended backup image which is backed up on said storage device.

4. The method according to claim 2, wherein said metadata are included in a first block of said extended backup image when the backup image is created.

5. The method according to claim 1, wherein said metadata includes information about a combined size of all tablespace files of each tablespace, a number of tablespace files of each tablespace, tablespace files containing table data and index data, and an I/O load of said tablespace files.

6. The method according to claim 1, wherein said metadata are stored utilizing a tree data structure, wherein a root node of the tree data structure contains information about the database, internal tree nodes of the tree data structure contain information concerning tablespaces of the database, and leaf nodes of the tree data structure represent information about tablespace files.

7. The method according to claim 1, wherein said metadata are collected when said backup image is created.

8. The method according to claim 1, wherein said metadata are generated by a database system and stored in system tables of said database system.

9. The method according to claim 1, wherein said optimized physical database layout of said backup image on said target system is stored utilizing a tree data structure.

10-14. (canceled)

15. A computer program product embodied within a computer usable medium and comprising a plurality of computer-executable instructions, which when executed by a computer, cause said computer to perform a method for automated disk I/O optimization of restored databases, said method comprising:
automatically generating metadata related to a database, wherein said metadata specifies a physical layout and disk I/O performance of said database on a source system,
generating a backup image of database data of said database,
backing up said metadata and said backup image on a storage device,
retrieving said metadata from said storage device,
accessing storage disk information indicating a number and size for each storage disk on a target system,
determining an optimized physical database layout of said backup image on said target system with respect to I/O performance based on said metadata and said storage disk information, and
restoring said backup image on said target system utilizing said optimized physical database layout.

16. The computer program product according to claim 15, wherein said determining comprises:
calculating a tablespace file size resulting in tablespace files of equal size per table space,
distributing said tablespace files over an available number of storage disks of said target system resulting in a balanced distribution of tablespace files,
rearranging said tablespace files of said balanced distribution utilizing a defined threshold of maximal read/write access,
identifying tablespace files exceeding said defined threshold, and
automatically rearranging said tablespace files exceeding said defined threshold to disks of said storage disks not exceeding said defined threshold.

17. The computer program product according to claim 15, wherein said metadata are added to said backup image to generate an extended backup image which is backed up on said storage device.

18. The computer program product according to claim 16, wherein said metadata are included in a first block of said extended backup image when the backup image is created.

19. The computer program product according to claim 15, wherein said metadata includes information about a combined size of all tablespace files of each tablespace, a number of tablespace files of each tablespace, tablespace files containing table data and index data, and an I/O load of said tablespace files.

20. The computer program product according to claim 15, wherein said metadata are stored utilizing a tree data structure, wherein a root node of the tree data structure contains information about the database, internal tree nodes of the tree data structure contain information concerning tablespaces of the database, and leaf nodes of the tree data structure represent information about tablespace files.

21. The computer program product according to claim 15, wherein said metadata are collected when said backup image is created.

22. The computer program product according to claim 15, wherein said metadata are generated by a database system and stored in system tables of said database system.

23. The computer program product according to claim 15, wherein said optimized physical database layout of said backup image on said target system is stored utilizing a tree data structure.

24. A system for automated disk I/O optimization of restored databases comprising:
means for automatically generating metadata related to a database, wherein said metadata specifies a physical layout and disk I/O performance of said database on a source system,
means for generating a backup image of database data of said database, and
backing up said metadata and said backup image on a storage device.

25. The system of claim 24, further comprising:
means for retrieving said metadata from said storage device,
means for accessing storage disk information indicating a number and size for each storage disk on a target system,
means for determining an optimized physical database layout of said backup image on said target system with respect to I/O performance based on said metadata and said storage disk information, and
means for restoring said backup image on said target system utilizing said optimized physical database layout.
